(19) United States
(12) Patent Application Publication
(10) Pub. No.: US 2024/0414556 A1
(43) Pub. Date: Dec. 12, 2024

(54) RESOURCE CONTROL DEVICE AND OPERATION METHOD OF RESOURCE CONTROL DEVICE

(71) Applicant: SK TELECOM CO., LTD., Seoul (KR)

(72) Inventor: Min Soo NA, Seoul (KR)

(21) Appl. No.: 18/702,916

(22) PCT Filed: Oct. 17, 2022
(86) PCT No.: PCT/KR2022/015755

§ 371 Date: Apr. 19, 2024

(30) Foreign Application Priority Data
Oct. 19, 2021 (KR) 10-2021-0139353

(51) Int. Cl. H04W 16/14; H04W 72/12; H04W 72/232

(52) U.S. Cl. CPC H04W 16/14; H04W 72/1215; H04W 72/232

(57) ABSTRACT

The present disclosure proposes a new scheme of resource control technology which allows optimal operation by enhancing the capacity of a control channel of NR. specifically, an NR PDCCH. during a DSS operation in which LTE/NR dynamically shares a frequency is proposed.

### TECHNICAL FIELD

The present disclosure relates to a dynamic spectrum sharing technology (DSS) in which LTE/NR dynamically shares a frequency.

This application is based on and claims priority to Korean Patent Application No. 10-2021-0139353, filed on Oct. 19, 2021, in the Korean Intellectual Property Office, the disclosure of which is herein incorporated by reference in its entirety.

### BACKGROUND ART

There is a constraint that an NR service supplier for providing an NR (5G) service needs to acquire a new frequency spectrum or re-adjust the spectrum already in use due to frequency division duplexing (FDD)-based spectrum resource occupancy in the conventional LTE (4G) system.

Due to such a constraint, the 5G NR standard suggests a dynamic spectrum sharing (DSS) technology in which LTE/NR dynamically shares a frequency in order to adapt to the conventional LTE and share a frequency spectrum dominantly used in the LTE with NR.

When introducing the DSS technology, the NR and the LTE may share/use the frequency spectrum of the low-frequency band of the conventional LTE, and thus the coverage of the NR can be provided using the low-frequency band.

In order for the LTE/NR to share the LTE frequency band in the DSS operation, a scheme of allocating a resource for LTE and a resource for NR in the operating frequency (=LTE frequency band) of the DSS is required.

In relation to this, a scheme of allocating the resource for NR through rate matching around a cell-specific reference signal (CRS) of LTE has been discussed in the current standard to enable the NR to use a subframe (e.g., LTE subframe) defined in the operating frequency of the DSS.

In the LTE system, a CRS transmitted to the entire cell is defined, which is one of a reference signal (RS) used to identify a channel state between a base station and a terminal. In the standard LTE subframe, transmission of the CRS is mapped to a designated resource location of a time-frequency grid according to a multi-input multi-output (MIMO) mode based on the number of transmission and reception antennas.

Such a CRS of LTE is an important to identify the channel state of LTE, and thus it is restricted in the current standard that the NR PDDCH cannot be allocated to a symbol in which LTE CRS transmission exists within an LTE subframe during a DSS operation.

Due to the NR PDCCH allocation restriction during the DSS operation, there are operational limitations which restrain the capacity of the NR PDCCH from being optimally operated in the current technology.

Accordingly, in the present disclosure, a new scheme of resource control technology which allows optimal operation by enhancing the capacity of the control channel of NR, specifically, the NR PDCCH, during a DSS operation in which LTE/NR dynamically shares the frequency is proposed.

### DISCLOSURE OF INVENTION

### Technical Problem

The technical problem of the present disclosure is to implement a new scheme of resource control technology which enables optimal operation by enhancing the capacity of a control channel of NR, specifically, an NR PDCCH, during a DSS operation in which LTE/NR dynamically shares the frequency.

### Solution to Problem

A resource control apparatus according to an embodiment of the present disclosure includes a resource control unit configured to, during a dynamic spectrum sharing (DSS) operation in which a frequency band of a first communication network is shared with a second communication network, cause a specific symbol within a subframe used as a control channel of the first communication network in an operating frequency of the DSS to be used as a symbol in which a specific reference signal (RS) of the first communication network coexists with a control channel of the second communication network.

Specifically, the first and second communication networks may be communication networks of LTE and NR, respectively, and the specific symbol may be a symbol in which only a resource for transmitting the specific RS is used, among symbols defined as an LTE physical downlink control channel (PDCCH) within the subframe.

Specifically, the resource control unit may be configured to allocate the specific symbol as a PDCCH of the second communication network, wherein a resource of a transmission location of the specific RS within the specific symbol performs puncturing processing of the PDCCH.

An operation method of a resource control apparatus according to an embodiment of the present disclosure includes performing resource control, during a dynamic spectrum sharing (DSS) operation in which a frequency band of a first communication network is shared with a second communication network, so as to cause a specific symbol within a subframe, used as a control channel of the first communication network in an operating frequency of the DSS, to be used as a symbol in which a specific reference signal (RS) of the first communication network coexists with a control channel of the second communication network.

A resource control apparatus according to an embodiment of the present disclosure includes an identification unit configured to identify a simultaneous access service in which an operating frequency of dynamic spectrum sharing (DSS) corresponding to sharing a frequency band of a first communication network with a second communication network is considered as a primary cell (PCell) and a separate frequency band is considered as a secondary cell (SCell), and a resource control unit configured to, in relation to the simultaneous access service, cause some functions among functions of a control channel defined in the operating frequency of the DSS to be performed on a control channel defined within the separate frequency band.

Specifically, the first and second communication networks may be communication networks of LTE and NR, respectively, and the SCell may be a cell which uses all of the separate frequency band for the NR only.

Specifically, said some functions may be NR uplink/downlink scheduling functions for the operating frequency of the DSS, the functions having been performed through an NR physical downlink control channel (PDCCH) defined in the operating frequency of the DSS.

An operation method of a resource control apparatus according to an embodiment of the present disclosure includes identifying a simultaneous access service in which an operating frequency of dynamic spectrum sharing (DSS) corresponding to sharing a frequency band of a first communication network with a second communication network is considered as a primary cell (PCell) and a separate frequency band is considered as a secondary cell (SCell), and performing resource control, in relation to the simultaneous access service, so as to cause some functions among functions of the control channel defined in the operating frequency of the DSS to be performed on the control channel defined within the separate frequency band.

A terminal apparatus according to an embodiment of the present disclosure includes a control unit configured to, during a dynamic spectrum sharing (DSS) operation in which a frequency band of a first communication network is shared with a second communication network, receive a specific symbol in which a specific reference signal (RS) of the first communication network coexists with a control channel of the second communication network among symbols within a subframe, used as control channels of the first communication network in an operating frequency of the DSS, and identify the specific RS of the first communication network and the control channel of the second communication network from the specific symbol.

A terminal apparatus according to an embodiment of the present disclosure may include a service use unit configured to use a simultaneous access service in which an operating frequency of dynamic spectrum sharing corresponding to sharing of a frequency band of a first communication network with a second communication network is considered as a primary cell (PCell) and a separate frequency band is considered as secondary cell (SCell), and a control unit configured to identify, in relation to the simultaneous access service, resource allocation information of the PCell through a control channel of the SCell.

### Advantageous Effects of Invention

Accordingly, according to a resource control apparatus and an operation method of a resource control apparatus of the present disclosure, during a DSS operation in which LTE/NR dynamically shares the frequency, the capacity of an NR PDCCH is enhanced through a scheme of increasing or saving a resource of a control channel of NR, specifically, the NR PDCCH, and thus can be optimally operated.

### BRIEF DESCRIPTION OF DRAWINGS

FIG. 1 illustrates a scheme of allocating an NR resource during a DSS operation.

FIG. 2 is a block diagram illustrating a configuration of a resource control apparatus according to an embodiment of the present disclosure.

FIG. 3 illustrates concept of coexistence of an LTE CRS and an NR PDCCH within a symbol according to the present disclosure.

FIG. 4 is a flow chart illustrating an operation method of a resource control apparatus according to an embodiment of the present disclosure.

FIG. 5 is a flow chart illustrating an operation method of a resource control apparatus according to another embodiment of the present disclosure.

FIG. 6 is a block diagram illustrating a configuration of a terminal apparatus according to an embodiment of the present disclosure.

### Best Mode For Carrying Out The Invention

Hereinafter, various embodiments of the present disclosure are described with reference to the accompanying drawings.

The present disclosure relates to a dynamic spectrum sharing technology in which LTE/NR dynamically shares a frequency.

There is a constraint that an NR service supplier for providing an NR (5G) service needs to acquire a new frequency spectrum or re-adjust the spectrum already in use due to frequency division duplexing (FDD)-based spectrum resource occupancy in the conventional LTE (4G) system.

Due to such a constraint, in order to adapt to the conventional LTE and share a frequency spectrum dominantly used in the LTE with NR, the 5G NR standard suggests a dynamic spectrum sharing (DSS) technology in which LTE/NR dynamically shares the frequency.

When introducing the DSS technology, the NR and the LTE may share/use the frequency spectrum on the low-frequency band of the conventional LTE, and thus the coverage of the NR can be provided using the low-frequency band.

In order for the LTE/NR shares the LTE frequency band in the DSS operation, a scheme of allocating a resource for LTE and a resource for NR in the operating frequency (=LTE frequency band) of the DSS is required.

In relation to this, in the current standard, to enable the NR to use a subframe (e.g., LTE subframe) defined in the operating frequency of the DSS, a scheme of allocating the resource for NR through rate matching around a cell-specific reference signal (CRS) of LTE has been discussed.

In the LTE system, as a reference signal (RS) used to identify a channel state between a base station and a terminal, a CRS transmitted to the entire cell is defined. In the standard LTE subframe, according to a multi-input multi-output (MIMO) mode according to the number of transmission and reception antennas, transmission of the CRS is mapped to a designated resource location of a time-frequency grid.

Such a CRS of LTE is an important RS to identify the channel state of LTE, and thus in the current standard, it is restricted that in allocating a resource for NR (specifically, an NR physical downlink control channel (PDCCH)) within an LTE subframe during a DSS operation, the NR PDDCH cannot be allocated to a symbol in which LTE CRS transmission exists.

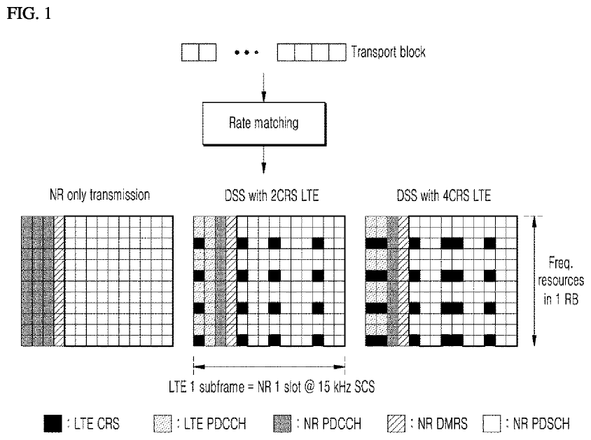

FIG. 1 illustrates a scheme of allocating an NR resource in an LTE subframe during a DSS operation.

As illustrated in FIG. 1, a current scheme follows restriction so that a resource for NR is allocated through rate matching around an LTE CRS in an LTE subframe during a DSS operation and an NR PDCCH cannot be allocated to a symbol in which LTE CRS transmission exists.

Accordingly, as illustrated in FIG. 1, according to a transmission location of the LTE CRS mapped according to a MIMO mode (e.g., 2CRS LTE_LTE Antenna Port 2 and 4CRS LTE_LTE Antenna Port 4), a resource for NR (NR PDCCH) is allocated through rate matching around the LTE CRS in the LTE subframe during the DSS operation.

Among symbols defined as LTE PDCCHs within the LTE subframe, there may be a symbol used as an LTE PDCCH as the transmission location of the LTE CRS exists, and such a symbol may be called an LTE PDCCH symbol for LTE CRS transmission.

In a case of the LTE PDCCH symbol for LTE CRS transmission, a resource remaining after excluding the resource for LTE CRS transmission is wasted, but due to restriction that the

NR PDCCH cannot be allocated to the symbol in which the LTE CRS transmission exists, and thus the remaining resource cannot be used for the NR PDDCH.

As described above, due to the NR PDCCH allocation restriction during the DSS operation, in the current technology, there is an operational restriction that the capacity of the NR PDCCH cannot be optimally operated during the DSS operation.

Accordingly, the present disclosure proposes a new scheme of resource control technology in which the capacity of the NR control channel, specifically, the NR PDCCH is enhanced and thus can be optimally operated during a DSS operation in which LTE/NR shares dynamically shares the frequency.

More specifically, the present disclosure proposes a new scheme of resource control technology which can enhance the capacity of the NR PDCCH through a scheme (hereinafter, referred to as a first embodiment) of increasing the resource of the NR PDCCH or a scheme (hereinafter, referred to as a second embodiment) of saving the resource of the NR PDCCH during the DSS operation.

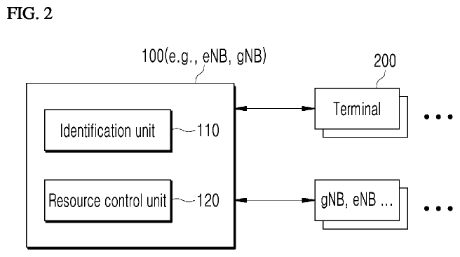

Hereinafter, referring to FIG. 2, a configuration of a resource control apparatus 100 according to an embodiment of the present disclosure is described in detail.

As illustrated in FIG. 2, the resource control apparatus 100 according to an embodiment of the present disclosure may include an identification unit 110 and a resource control unit 120.

The resource control apparatus 100 according to an embodiment of the present disclosure may be an LTE base station (eNB) or an NR base station (gNB). The resource control apparatus 100 may be a separate apparatus associated with the eNB and the gNB.

All or at least a part of the configuration of the resource control apparatus 100 may be implemented in the form of a hardware module or a software module, or may be implemented in the form of a combination of a hardware module and a software module.

The resource control apparatus 100 according to an embodiment of the present disclosure implements, through the above-described configuration, the enhancement of the capacity of the NR PDCCH during the DSS operation to be defined in the present disclosure, and hereinafter, each configuration within the resource control apparatus 100 is described in more detail.

Hereinafter, referring to FIG. 2, a first embodiment of enhancing the capacity of the NR PDCCH in a scheme of increasing the resource of the NR PDCCH during the DSS operation is described.

The resource control apparatus 100 according to the first embodiment of the present disclosure includes a resource control unit 120.

The resource control unit 120 performs a function of causing, during a dynamic spectrum sharing (DSS) operation in which a frequency band of a first communication network is shared with a second communication network, a specific symbol within a subframe, used as a control channel of the first communication network, to be used as a symbol in which a specific reference signal (RS) of the first communication network coexists with a control channel of the second communication network.

Here, the first and second communication networks may mean communication networks of LTE and NR.

That is, the resource control unit 120 may perform all functions of allocating, during a DSS operation in which the frequency band of LTE is shared with NR, a resource for LTE and a resource for NR in the operating frequency (=LTE frequency band) of the DSS.

Specifically, the resource control unit 120 causes a specific symbol used as an LTE control channel, i.e., an LTE PDCCH in a subframe (i.e., an LTE subframe) defined in the operating frequency of the DSS to be used as a symbol in which a specific RS (hereinafter, referred to as an LTE CRS) of LTE coexists with the control channel of NR, i.e., the NR PDCCH.

To describe this in detail, in the present disclosure, as described above, according to the transmission location of the LTE CRS mapped according to a MIMO mode (e.g., 2CRS LTE_LTE Antenna Port 2 and 4CRS LTE_LTE Antenna Port 4), the rate matching around the LTE CRS in the LTE subframe during the DSS operation is identified.

In this case, the resource control unit 120 may identify the existence of the specific symbol used as the LTE PDCCH in the LTE subframe.

Specifically, the specific symbol may mean a symbol in which a resource for transmitting the LTE CRS is used among symbols defined as LTE PDCCHs within the subframe (i.e., LTE subframe) defined in the operating frequency of the DSS.

That is, in the present disclosure, the specific symbol means a symbol used as an LTE PDCCH as the transmission location of the LTE CRS exists, among the symbols defined as LTE PDCCHs in the LTE subframe, and in the description above, such a symbol has been mentioned as an LTE PDCCH symbol for LTE CRS transmission.

Referring to FIG. 1, in a case of a 4CRS LTE MIMO mode (LTE antenna port 4) during the DSS, it may be described that the second symbol (symbol 1) in the LTE subframe corresponds to a symbol in which the transmission location of the LTE CRS exists and which is used as an LTE PDCCH, i.e., the specific symbol mentioned in the present disclosure.

According to the MIMO mode, the location of the specific symbol mentioned in the present disclosure may vary within the LTE subframe, and the specific symbol may not exist.

However, in the description below, the case of the 4CRS LTE MIMO mode (LTE antenna port 4) will be described by mentioning a case in which the second symbol (symbol 1) within the LTE subframe corresponds to the specific symbol.

In the process of identifying the rate matching around the LTE CRS in the LTE subframe during the DSS operation, when identifying the existence of the specific symbol in which only a resource for transmitting the LTE CRS is used, the resource control unit 120 causes the corresponding symbol to be used as a symbol in which the LTE CRS coexists with the NR PDCCH.

To describe this in more detail, the resource control unit 120 may allocate the specific symbol, the existence of which has been identified in the LTE subframe during the DSS operation, as the NR PDDCH.

To described in in a specific example, the resource control unit 120 may allocate/define the second and third symbols (symbols 1 and 2) within the LTE subframe as NR PDCCHs, unlike a scheme of allocating only the third symbol (symbol 2) within the LTE subframe as the NR PDCCH due to the restriction that the NR PDDCH cannot be allocated to the symbol in which the LTE CRS transmission exists in a case of the 4CRS LTE MIMO mode (LTE antenna port 4) during the DSS operation.

In addition, the resource control unit 120 may allocate the resource of the LTE CRS transmission location as a resource for LTE CRS transmission in the specific symbol (e.g., symbol 1) within the LTE subframe.

To describe this in a specific example, the resource control unit 120 may allocate a resource overlapping with the LTE CRS transmission location within the specific symbol (e.g., symbol 1) to the NR PDCCH in a scheme of puncturing the NR PDCCH, and allocate the resource of the LTE CRS transmission location as a resource for LTE CRS transmission, thereby minimizing the interference between the NR PDDCH and the LTE CRS in the specific symbol (e.g., symbol 1).

As described above, in the present disclosure, during the DSS operation, a specific symbol (e.g., symbol 1) in the LTE subframe, in which a resource remaining after excluding the resource for transmitting the LTE CRS is wasted, is allocated as the NR PDCCH, and the interference between the NR PDCCH and the LTE CRS is minimized through resource puncturing of the LTE CRS transmission location within the specific symbol (e.g., symbol 1), whereby the specific symbol (e.g., symbol 1) may be used as a symbol in which the LTE CRS coexists with the NR PDCCH.

Accordingly, in the present disclosure, the specific symbol wasted in the LTE subframe during the DSS operation is allocated/used as the NR PDCCH, and thus the capacity of the NR PDCCH can be enhanced in a scheme of increasing the resource of the NR PDCCH during the DSS operation.

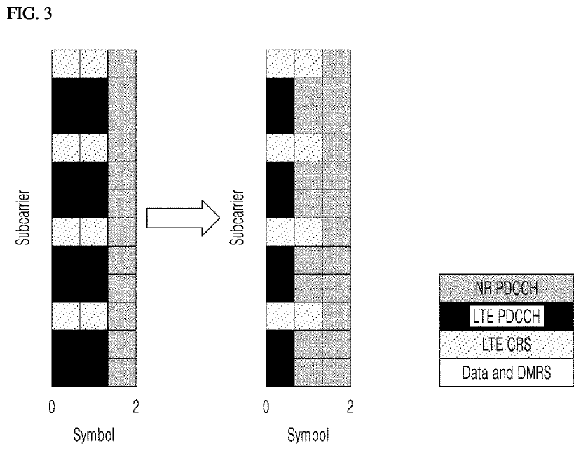

FIG. 3 illustrates concept of coexistence of an LTE CRS and an NR PDCCH within a symbol according to the above-described first embodiment.

FIG. 3 illustrates, as an example, the case of the 4CRS LTE MIMO mode (LTE antenna port 4) during the DSS operation illustrated in FIG. 1, and illustrates symbols 0, 1, and 2 corresponding to LTE/NR PDCCHs to simplify the drawings.

As illustrated in FIG. 3, the case of the 4CRS LTE MIMO mode (LTE antenna port 4) corresponds to a scheme in which the first and second symbols (symbols 0 and 1) are within the LTE subframe are allocated as LTE PDCCHs, and the third symbol (symbol 2) is allocated as an NR PDCCH (left).

In this case, it may be described that the second symbol (symbol 1) within the LTE subframe corresponds to a symbol used as an LTE PDCCH as the transmission location of the LTE CRS exists, i.e., the specific symbol mentioned in the present disclosure.

On the other hand, according to the present disclosure, the second and third symbols (symbols 1 and 2) within the LTE subframe during the DSS operation are allocated/defined as NR PDCCHs, but for a resource overlapped with the LTE CRS transmission location, the NR PDCCH is punctured, and thus the specific symbol (e.g., symbol 1) is to be used as a symbol in which the LTE CRS coexists with the NR PDCCH.

Moreover, in the present disclosure, if the capacity to be transmitted through the NR PDCCH is sufficient by only using the specific symbol (e.g., symbol 1) operated so that the LTE CRS coexists with the NR PDCCH within the LTE subframe during the DSS operation, the third symbol (symbol 2) within the LTE subframe may not be allocated as the NR PDCCH, and symbols from the third symbol (symbol 2) may be allocated as LTE/NR physical downlink shared channels (PDSCHs).

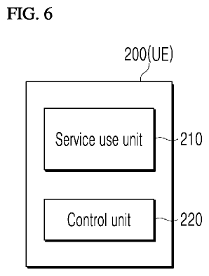

Hereinafter, referring to FIG. 6, with respect to a terminal apparatus of the present disclosure, operated to correspond to the above-described first embodiment, the configuration thereof is described in detail.

A terminal apparatus 200 according to the first embodiment of the present disclosure includes a control unit 220.

The control unit 220 performs a function of receiving, during a DSS operation in which a frequency band of LTE is shared with NR, a specific symbol in which a specific RS (hereinafter, referred to as an LTE CRS) of LTE coexists with a control channel of NR, i.e., NR PDCCH in a subframe (i.e., an LTE subframe) defined in an operating frequency of DSS, and identifying the LTE CS and the NR PDCCH from the specific symbol.

To describe this in detail, in the present disclosure, as described above, according to the transmission location of the LTE CRS mapped according to the MIMO mode (e.g., 2CRS LTE_LTE Antenna Port 2 and 4CRS LTE_LTE Antenna Port 4), the rate matching around the LTE CRS is identified in the LTE subframe during the DSS operation.

In this case, the resource control apparatus 100 (e.g., eNB) may identify the existence of a specific symbol used as an LTE PDCCH in an LTE subframe (e.g., a symbol in which only a resource for transmitting an LTE CRS is used among symbols defined as LTE PDCCHs).

In addition, the resource control apparatus 100 (e.g., eNB) may transfer, to each terminal apparatus 200 through various information transfer schemes (e.g., a system information block (SIB), downlink control information (DCI), etc.), existence and location information of the specific symbol (e.g., a symbol in which only a resource for transmitting an LTE CRS is used among symbols defined as LTE PDCCHs), and notify of the same.

In the description below, the case of the 4CRS LTE MIMO mode (LTE antenna port 4) will be described by mentioning a case in which the second symbol (symbol 1) within the LTE subframe corresponds to the specific symbol.

Accordingly, in the case of the 4CRS LTE MIMO mode (LTE antenna port 4) during the DSS operation, the terminal apparatus 200 of the present disclosure, specifically, the control unit 220, may use the second and third symbol (symbols 1 and 2) within the LTE subframe for NR PDCCH reception, unlike the existing scheme of using only the third symbol (symbol 2) within the LTE subframe for NR PDCCH reception.

That is, in the case of the 4CRS LTE MIMO mode (LTE antenna port 4) during the DSS operation, the control unit 220 may receive the second and third symbols (symbols 1 and 2) within the LTE subframe as NR PDCCHs, and identify the NR PDCCH from the specific symbol (symbol 1), wherein the LTE CRS and the NR PDCCH may be identified from the specific symbol (symbol 1) by using a scheme of identifying the LTE CRS from a resource in which the NR PDCCH within the specific symbol (e.g., symbol 1) is punctured.

The control unit 220 may receive and identify the NR PDDCH through the third symbol (symbol 2) within the LTE subframe as in the existing scheme.

As described above, according to the first embodiment of the present disclosure, during the DSS operation in which LTE/NR dynamically shares the frequency, through a scheme of defining a symbol in which the LTE CRS coexists with the NR PDCCH, the capacity of the NR PDDCH can be enhanced by increasing the resource of the NR PDCCH.

Next, hereinafter, referring to FIG. 2, a second embodiment of enhancing the capacity of an NR PDCCH in a scheme of saving a resource of the NR PDCCH during a DSS operation is described.

The resource control apparatus 100 according to the second embodiment of the present disclosure includes an identification unit 110 and a resource control unit 120.

The identification unit 110 performs a function of identifying a simultaneous access service in which an operating frequency of dynamic spectrum sharing (DSS) corresponding to sharing a frequency band of a first communication network with a second communication network is considered as a primary cell (PCell) and a separate frequency band is considered as a secondary cell (SCell)

Here, the first and second communication networks may mean communication networks of LTE and NR.

In addition, the simultaneous access service in which the operating frequency of the DSS is considered as a PCell and the separate frequency is considered as the SCell may mean a carrier aggregation (CA)-based service and a dual connectivity (DC)-based service.

That is, the identification unit 110 may identify a simultaneous access service in which an operating frequency (=LTE frequency band) of DSS corresponding to sharing a frequency band of LTE with NR is considered as a PCell and the separate frequency band is considered as a SCell, i.e., a CA or DC-based service.

The resource control unit 120 performs a function of causing, in relation to the simultaneous access service (e.g., CA or DC-based service) identified by the identification unit 110, some functions among functions of a control channel defined in the operating frequency of the DSS to be performed in the control channel defined in the separate frequency.

To describe this in detail, in relation to the simultaneous access service (e.g., CA or DC-based service), the above-described SCell may mean a cell in which the entire separate frequency band is used for NR.

That is, the simultaneous access service mentioned in the present disclosure means a CA or DC-based service in which the operating frequency (=LTE frequency band) of the DSS is considered as a PCell and the NR frequency is considered as an SCell.

Accordingly, the resource control unit 120 may cause, in relation to the simultaneous access service (e.g., CA or DC-based service), some functions among functions of the LTE or NR PDCCH defined in the operating frequency of the DSS to be performed in the NR PDCCH defined within the NR frequency band.

To describe a more detailed embodiment, the above-described some functions may be an NR uplink/downlink scheduling function for the operating frequency of the DSS which has been performed through an NR physical downlink control channel (PDCCH) defined in the operating frequency of the DSS.

In the existing scheme, during the DSS operation, LTE uplink/downlink scheduling (PDSCH/PUSCH scheduling) is performed through the LTE PDCCH defined in the operating frequency of the DSS, and NR PDSCH/PUSCH scheduling is performed through the NR PDCCH defined in the operating frequency of the DSS.

In the CA or DC-based service in which the operating frequency (=LTE frequency band) of the DSS is considered as a PCell and the NR frequency is considered as an SCell during the DSS operation, resource sharing based on communication between the NR PDCCH of the PCell within the operating frequency of the DSS and the NR PDCCH of the SCell within the NR frequency may be possible upon the CA or DC technology.

To describe this in detail, the resource control unit 120 may allocate a resource for NR PDSCH/PUSCH scheduling of the DSS to the NR PDCCH defined within the NR frequency band. In addition, the resource control unit 120 may cause, in relation to the simultaneous access service (e.g., CA or DC-based service), the NR PDSCH/PUSCH scheduling having been performed through the NR PDCCH defined in the operating frequency of the DSS to be performed through the NR PDCCH of the SCell by using the resource allocated within the defined NR PDCCH of the NR frequency band.

That is, the resource control unit 120 may transmit, through the NR PDCCH defined in the NR frequency band, i.e., the NR PDCCH of the SCell, resource allocation information (NR PDSCH/PUSCH scheduling information) for the PCell having been transmitted through the NR PDCCH defined in the operating frequency of the DSS, thereby causing the NR PDSCH/PUSCH scheduling of the PCell to be performed through the NR PDCCH of the SCell.

Accordingly, in the CA or DC-based service in which the operating frequency (=LTE frequency band) of the DSS is considered as a PCell and the NR frequency is considered as an SCell, NR PDSCH/PUSCH scheduling of not only the NR SCell but also the PCell in the DSS operation may be performed through the NR PDCCH of the SCell defined in the NR frequency band.

Hereinafter, referring to FIG. 6, with respect to a terminal apparatus of the present disclosure, operated to correspond to the above-described second embodiment, the configuration thereof is described in detail.

A terminal apparatus 200 according to the second embodiment of the present disclosure includes a service use unit 210 and a control unit 220.

The service use unit 210 performs a function of using a simultaneous access service, specifically, a CA or DC-based service in which an operating frequency (=LTE frequency band) of the DSS is considered as a PCell and an NR frequency is considered as an SCell.

The control unit 220 performs a function of identifying, in relation to the above-described simultaneous access service (e.g., the CA or DC-based service) used in the terminal apparatus 200, resource allocation information for the PCell through a control channel of the SCell.

To describe this in detail, the control unit 220 may identify, in relation to the simultaneous access service (e.g., the CA or DC-based service), resource allocation information (NR PDSCH/PUSCH scheduling information) for the PCell through the NR PDCCH of the SCell.

To describe this in detail, the resource control apparatus 100 (e.g., eNB) in the present disclosure may allocate, in relation to the simultaneous access service (e.g., the CA or DC-based service), a resource for NR PDSCH/PUSCH scheduling of the DSS to the NR PDCCH defined within the NR frequency band, and may transfer, to the terminal apparatus 200 through various information transfer schemes (e.g., a system information block (SIB), downlink control information (DCI), etc.), the information on the resource allocation, and notify of the same.

Accordingly, the terminal apparatus 200 of the present disclosure, specifically, the control unit 220 may receive/identify resource allocation information (NR PDSCH/PUSCH scheduling information) for the PCell through the NR PDCCH of the SCell rather than the NR PDCCH defined in the operating frequency of the DSS when using the simultaneous access service in which the operating frequency (=LTE frequency band) of the DSS is considered as a PCell and the NR frequency is considered as an SCell.

As described above, according to the second embodiment of the present disclosure, during the DSS operation in which the LTE/NR dynamically shares the frequency, through a scheme of implementing NR PDSCH/PUSCH scheduling of the DSS operation PCell by using the NR PDCCH of the SCell, the NR PDCCH resource of the DSS operation PCell can be saved, and thus the capacity of the NR PDCCH can be enhanced.

Accordingly, in the present disclosure, during the DSS operation, through embodiments of increasing or saving the control channel of the NR, specifically, the resource of the NR PDCCH, the capacity of the NR PDCCH is enhanced and thus can be optimally operated.

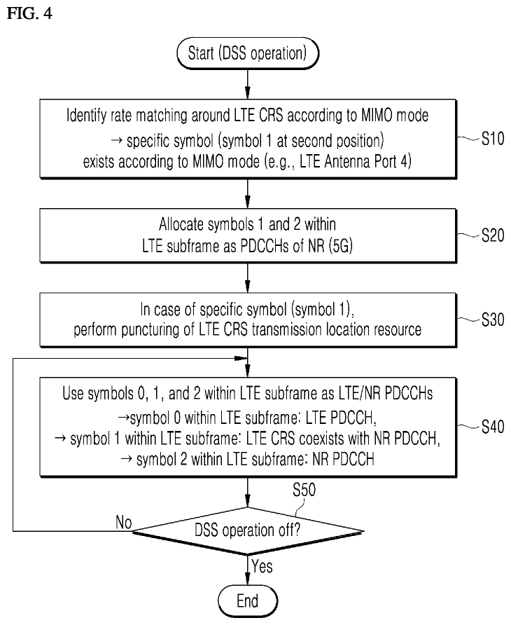

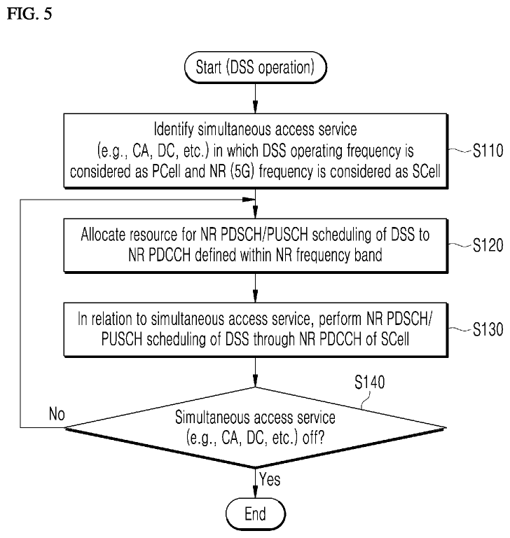

Hereinafter, referring to FIGS. 4 and 5, an operation method of a resource control apparatus according to an embodiment of the present disclosure is described.

First, referring to FIG. 4, the operation method of the resource control apparatus according to the first embodiment of the present disclosure is described.

In the operation method of the resource control apparatus according to the present disclosure, a resource control apparatus 100 identifies, in the process of identifying rate matching around an LTE CRS within an LTE subframe during a DSS operation, the existence of a specific symbol in which only a resource for transmitting the LTE CRS is used (S10).

Specifically, referring to FIG. 1, in a case of a 4CRS LTE MIMO mode (LTE antenna port 4) during the DSS operation, it may be described that the second symbol (symbol 1) within the LTE subframe corresponds to a symbol used as an LTE PDCCH as there is a transmission location of the LTE CRS exists, i.e., the specific symbol mentioned in the present disclosure.

According to the MIMO mode, the location of the specific symbol within the LTE subframe, mentioned in the present disclosure, may vary, and the specific symbol may not exist.

However, hereinafter, the case of the 4CRS LTE MIMO mode (LTE antenna port 4) is described by mentioning a case where the second symbol (symbol 1) within the LTE subframe corresponds to the specific symbol.

In the operation method of the resource control apparatus according to the present disclosure, when having identified the existence of the specific symbol (S10), the resource control apparatus 100 causes the corresponding symbol to be used as a symbol in which the LTE CRS coexists with an NR PDDCH (S20 and S30).

To describe this in more detail, in the operation method of the resource control apparatus according to the present disclosure, the resource control apparatus 100 allocates, as an NR PDCCH, the specific symbol, the existence of which has been identified from the LTE subframe during the DSS operation (S20).

To describe this in a detailed example, in the 4CRS LTE MIMO mode (LTE antenna port 4) during the DSS operation, the resource control apparatus 100 may allocate/define, as NR PDCCHs, the second and third symbols (symbols 1 and 2) within the LTE subframe, unlike the scheme of allocating only the third symbol (symbol 2) within the LTE subframe as an NR PDCCH due to the restriction that the NR PDCCH cannot be allocated to the symbol in which LTE CRS transmission exists (S20).

In addition, in the operation method of the resource control apparatus according to the present disclosure, the resource control apparatus 100 may allocate a resource of the LTE CRS transmission location to the specific symbol (e.g., symbol 1) within the LTE subframe, as a resource for LTE CRS transmission (S30).

To describe this in a detailed example, the resource control apparatus 100 may allocate may allocate a resource overlapping with the LTE CRS transmission location within the specific symbol (e.g., symbol 1) to the NR PDCCH in a scheme of puncturing the NR PDCCH, and allocate the resource of the LTE CRS transmission location as a resource for LTE CRS transmission (S30), thereby minimizing the interference between the NR PDDCH and the LTE CRS in the specific symbol (e.g., symbol 1).

As described above, in the operation method of the resource control apparatus according to the present disclosure, during the DSS operation, a specific symbol (e.g., symbol 1) in the LTE subframe, in which a resource remaining after excluding the resource for transmitting the LTE CRS is wasted, is allocated as the NR PDCCH, and the interference between the NR PDCCH and the LTE CRS is minimized through resource puncturing of the LTE CRS transmission location within the specific symbol (e.g., symbol 1), whereby the specific symbol (e.g., symbol 1) may be used as a symbol in which the LTE CRS coexists with the NR PDCCH.

In the present disclosure, the first to third symbols (symbols 0, 1, and 2) within the LTE subframe during the DSS operation are used as LTE/NR PDCCHs, specifically, symbol 0 may be used as an LTE PDCCH, symbol 1 may be used as a symbol in which the LTE CRS coexists with the NR PDCCH, and symbol 3 may be used as an NR PDDCH (S40).

Accordingly, in the present disclosure, by allocating/using, as an NR PDCCH, the specific symbol wasted in the LTE subframe during the DSS operation, the capacity of the NR PDCCH can be enhanced in a scheme of increasing the resource of the NR PDCCH during the DSS operation.

Next, referring to FIG. 5, the operation method of the resource control apparatus according to the second embodiment of the present disclosure is described.

In the operation method of the resource control apparatus according to the present disclosure, the resource control apparatus 100 may identify a simultaneous access service in which an operating frequency (=LTE frequency band) of the DSS corresponding to sharing a frequency band of LTE with NR is considered as a PCell and an NR frequency is considered as an SCell, i.e., a CA or DC-base service (S110).

In addition, the operation method of the resource control apparatus according to the present disclosure, the resource control apparatus 100 may cause, in relation to the simultaneous access service (e.g., CA or DC-based service) having been identified in operation S110, some functions among functions of an LTE or NR PDCCH defined in the operating frequency of the DSS to be performed in the NR PDCCH defined within the NR frequency (S120 and S130).

To describe this in a more detailed embodiment, the above-described some functions may be NR uplink/downlink scheduling functions for the operating frequency of the DSS, which have been performed through an NR physical downlink control channel (PDCCH) defined in the operating frequency of the DSS.

In the existing scheme, during the DSS operation, LTE uplink/downlink scheduling (PDSCH/PUSCH scheduling) is performed through the LTE PDCCH defined in the operating frequency of the DSS, and NR PDSCH/PUSCH scheduling is performed through the NR PDCCH defined in the operating frequency of the DSS.

In the CA or DC-based service in which the operating frequency (=LTE frequency band) of the DSS is considered as a PCell and the NR frequency is considered as an SCell during the DSS operation, resource sharing based on communication between the NR PDCCH of the PCell within the operating frequency of the DSS and the NR PDCCH of the SCell within the NR frequency may be possible upon the CA or DC technology.

To describe this in detail, in the operation method of the resource control apparatus according to the present disclosure, the resource control apparatus 100 may allocate a resource for NR PDSCH/PUSCH scheduling of the DSS to the NR PDCCH defined within the NR frequency band (S120).

In addition, the resource control apparatus 100 may cause, in relation to the simultaneous access service (e.g., CA or DC-based service), the NR PDSCH/PUSCH scheduling having been performed through the NR PDCCH defined in the operating frequency of the DSS to be performed through the NR PDCCH of the SCell by using the resource allocated within the defined NR PDCCH of the NR frequency band (S130).

Accordingly, in the CA or DC-based service in which the operating frequency (=LTE frequency band) of the DSS is considered as a PCell and the NR frequency is considered as an SCell, NR PDSCH/PUSCH scheduling of not only the NR SCell but also the PCell in the DSS operation may be performed through the NR PDCCH of the SCell defined in the NR frequency band (S130).

In addition, in the operation method of the resource control apparatus according to the present disclosure, the resource control apparatus 100 may cause the function of performing NR PDSCH/PUSCH scheduling of not only the NR SCell but also the PCell in the DSS operation through the NR PDCCH of the SCell to be maintained unless the simultaneous access service (e.g., CA or DC-based service) having been identified this time is not off (No in S140).

As described above, in the operation method of the resource control apparatus according to the present disclosure, during the DSS operation in which the LTE/NR dynamically shares the frequency, through a scheme of implementing NR PDSCH/PUSCH scheduling of the DSS operation PCell by using the NR PDCCH of the SCell, the NR PDCCH resource of the DSS operation PCell can be saved, and thus the capacity of the NR PDCCH can be enhanced.

Accordingly, in the present disclosure, during the DSS operation in which the LTE/NR dynamically shares the frequency, through embodiments of increasing or saving the control channel of the NR, specifically, the resource of the NR PDCCH, the capacity of the NR PDCCH is enhanced and thus can be optimally operated.

An operation method of a resource control apparatus according to an embodiment of the present disclosure may be implemented in the form of a program command which can be performed by various computer means and may be recorded in a non-transitory computer-readable medium. The computer readable medium may include a program command, a data file, a data structure, and the like independently or in combination. The program command recorded in the medium may be things specially designed and configured for the present disclosure, or things that are well known to and can be used by those skilled in the computer software related art. Examples of the computer-readable recording medium include magnetic media such as hard disks, floppy disks and magnetic tapes, optical media such as a Compact Disc Read-Only Memory (CD-ROM) and a Digital Versatile Disc (DVD), magneto-optical media such as floppy disks, and hardware devices such as a Read-Only Memory (ROM), a Random Access Memory (RAM) and a flash memory, which are specially configured to store and perform program commands. Examples of the program command include a machine language code generated by a compiler and a high-level language code executable by a computer through an interpreter and the like. The hardware device may be configured to operate as one or more software modules in order to perform operations of the present disclosure, and vice versa.

Although the present disclosure has been described in detail with reference to exemplary embodiments, the present disclosure is not limited thereto and it is apparent to those skilled in the art that various modifications and changes can be made thereto without departing from the scope of the present disclosure.

1. A resource control apparatus comprising a resource control unit configured to, during a dynamic spectrum sharing (DSS) operation in which a frequency band of a first communication network is shared with a second communication network:
cause a specific symbol within a subframe used as a control channel of the first communication network in an operating frequency of the DSS to be used as a symbol in which a specific reference signal (RS) of the first communication network coexists with a control channel of the second communication network; or
cause a part of functions of the control channel defined in the operating frequency of the DSS to be performed on a control channel defined within other frequency band.

2. The resource control apparatus of claim 1, wherein the first and second communication networks are communication networks of LTE and NR, respectively, and
wherein the specific symbol is one of symbols defined as an LTE physical downlink control channel (PDCCH) within the subframe, and is used only by a resource for transmitting the specific RS.

3. The resource control apparatus of claim 1, wherein the resource control unit is configured to allocate the specific symbol as a PDCCH of the second communication network, and perform puncturing processing of the PDCCH for a resource of a transmission location of the specific RS within the specific symbol.

4. The resource control apparatus of claim 1, further comprising an identification unit configured to identify a simultaneous access service in which the operating frequency of the DSS is a primary cell (PCell) and other frequency band is a secondary cell (SCell),
wherein the resource control unit is configured to, in relation to the simultaneous access service, cause a part of functions of the control channel defined in the operating frequency of the DSS to be performed on the control channel defined within the other frequency band.

5. The resource control apparatus of claim 4, wherein the first and second communication networks are communication networks of LTE and NR, respectively, and
wherein the SCell is a cell which uses all of the other frequency band for the NR only.

6. The resource control apparatus of claim 5, wherein the part of functions are NR uplink/downlink scheduling function for the operating frequency of the DSS, which has been performed through an NR physical downlink control channel (PDCCH) defined in the operating frequency of the DSS.

7. An operation method of a resource control apparatus, the method comprising performing resource control, during a dynamic spectrum sharing (DSS) operation in which a frequency band of a first communication network is shared with a second communication network, so as to:
cause a specific symbol within a subframe, used as a control channel of the first communication network in an operating frequency of the DSS, to be used as a symbol in which a specific reference signal (RS) of the first communication network coexists with a control channel of the second communication network; or
cause a part of functions of the control channel defined in the operating frequency of the DSS to be performed on a control channel defined within other frequency band.

8. The method of claim 7, further comprising identifying a simultaneous access service in which the operating frequency of the DSS is a primary cell (PCell) and the other frequency band is a secondary cell (SCell),
wherein the performing of the resource control comprises, in relation to the simultaneous access service, causing a part of functions of the control channel defined in the operating frequency of the DSS to be performed on the control channel defined within the other frequency band.

9. A terminal apparatus comprising a control unit configured to, during a dynamic spectrum sharing (DSS) operation in which a frequency band of a first communication network is shared with a second communication network:
receive a specific symbol in which a specific reference signal (RS) of the first communication network coexists with a control channel of the second communication network, the specific symbol being one of symbols within a subframe used as control channels of the first communication network in an operating frequency of the DSS; and
identify the specific RS of the first communication network and the control channel of the second communication network from the specific symbol.

10. A terminal apparatus comprising:
a service use unit configured to use a simultaneous access service in which an operating frequency of dynamic spectrum sharing (DSS) corresponding to sharing of a frequency band of a first communication network with a second communication network is a primary cell (PCell) and other frequency band is secondary cell (SCell); and
a control unit configured to identify. in relation to the simultaneous access service. resource allocation information of the PCell through a control channel of the SCell.
